(19) United States
(12) Patent Application Publication
(10) Pub. No.: US 2021/0399393 A1
(43) Pub. Date: Dec. 23, 2021

(54) ELECTRICAL CONNECTION OF ELECTRODE TABS OF AN ELECTROMECHANICAL CELL

(71) Applicant: STOREDOT LTD., Herzeliya (IL)

(72) Inventors: Assaf Zehavi, Haifa (IL); Nir Dolev, Lehavim (IL); Tzemah Kislev, Mazkeret-Bathya (IL); Daniel Aronov, Netanya (IL)

(73) Assignee: STOREDOT LTD., Herzeliya (IL)

(21) Appl. No.: 17/304,647

(22) Filed: Jun. 23, 2021

Related U.S. Application Data
(60) Provisional application No. 62/705,362, filed on Jun. 23, 2020.

(51) Int. Cl. H01M 50/548; H01M 10/04

(52) U.S. Cl. CPC H01M 50/548; H01M 10/0431

(57) ABSTRACT

An electrochemical cell that may include a cathode sheet; a cathode tab that extends from the cathode sheet; an anode sheet; an anode tab that extends from the anode sheet, the second direction differs from the first direction; one or more separator sheets; and a first electrical connecting unit. The cathode sheet, the anode sheet and the one or more separator sheets are wound around a common axis to form multiple windings; wherein the one or more separator sheets separate between the anode sheet and the cathode sheet. The first electrical connecting unit mechanically and electrically contacts a first portion of a first electrode tab, the first portion belongs to a first winding of the multiple windings; wherein the first electrode tab is one of the anode tab and the cathode tab.

### CROSS REFERENCE

This application claims priority from U.S. provisional patent 62/705,362 filing date Jun. 23, 2020 which is incorporated herein by reference.

### BACKGROUND

An electrochemical cell includes one or more positive electrodes and one or more negative electrodes. Each electrode may include a conductive sheet (such as but not limited to Aluminum, Copper, Nickel) which is coated with one or more chemical substances that serve as anode or cathode active and auxiliary materials.

Part of the conductive sheet is not coated, so that the bare part functions as a current collector, which is being connected to another electrical conductor, electrical connecting unit, which leads the current from the electrode to the next electrical connection.

Connecting the electrodes has a few challenges:
a. Minimizing connection volume, thus, maximizing volumetric energy density (Watt-h/liter)
b. Reducing contact electrical resistance and reducing current densities (Amp/cm²).
c. Making a connection with good manufacturability (fast, simple and cheap process).
d. Making a long last and stable connection.
e. Homogeneity current distribution.
f. Good thermal conductivity.

There is a growing need to overcome said challenges.

### SUMMARY

There may be provide a method and a cell for electrical connection of electrode tabs of an electromechanical cell.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates examples of parts of an electrochemical cell;

FIG. 2 illustrates examples of parts of an electrochemical cell;

FIG. 3 illustrates examples of parts of an electrochemical cell;

FIG. 4 illustrates examples of parts of an electrochemical cell;

FIG. 5 illustrates examples of parts of an electrochemical cell;

FIG. 6 illustrates examples of some parts of an electrochemical cell;

FIG. 7 illustrates examples of some parts of an electrochemical cell;

FIG. 8 illustrates examples of some parts of an electrochemical cell;

FIG. 9 illustrates examples of some parts of an electrochemical cell;

FIG. 10 illustrates examples of some parts of an electrochemical cell;

FIG. 11 illustrates examples of some parts of an electrochemical cell;

FIG. 12 illustrates examples of some parts of an electrochemical cell; and

FIG. 13 illustrates an example of a method.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a battery capable of executing the method and/or to a battery manufactured by the method.

Any reference in the specification to a battery should be applied mutatis mutandis to a method for operating the battery and/or to a method for manufacturing the battery.

Any combination of any module or unit listed in any of the figures, any part of the specification and/or any claims may be provided.

Any combination of any steps of any method illustrated in the specification and/or drawings may be provided.

Any combination of any subject matter of any of claims may be provided.

The following application may refer to one or more electrical connection units. Any reference to an electrical connection unit may be applied mutatis mutandis to multiple electrical connection units.

The suggested electrochemical cell and method provide a current collector to be connected to terminal by an electrical connecting unit, which reduces the current densities and/or resistance, improve thermal conductivity and distribute the current in a more homogenous manner.

An electrical connecting unit connects the current collector and external conductive material, for example cell terminal.

The connection can be easy and/or fast to assembly, can eliminate welding steps and increasing energy density. Possibility to serial and parallel connection inside same package (increasing cell to pack ratio).

Each cell may include at least one electrical connecting unit.

The electrical connecting unit can be made from conductive material.

Examples for electrical connecting units materials. For positive side: aluminum, gold, nickel, stainless steel, metal alloys, and any combination thereof. For negative side: copper, nickel, stainless steel, gold, metal alloys, and any combination thereof.

The electrical connecting unit can be made of shape-memory alloy, so that after the assembly, the part is being heated, changes its shape, and the clamping process is taking place in-situ, after the cell is fully assembled.

The electrical connecting unit can be made of one or more parts.

The electrical connecting unit may have a hollow structure.

The electrical connecting unit may be provided in different shapes and form factor.

The electrical connecting unit can be part of the cell body, cell cap or any other part of the cell structure.

The cell assembly can connect to one or more cell assembly in column and/or in parallel and can create a module.

The module can have monitoring between any cell assemblies and/or on any electrical connecting unit (negative or positive) such as but not limited to voltage resistance etc.

The module can have electrical isolative part between any cell assemblies and/or on any electrical connecting unit (negative or positive).

The connection between the cells can be made between the different electrical connecting units (negative to negative, negative to positive, positive to positive).

An electrical connecting unit can include different cell assembly's connection, i.e. electrical connecting unit may be connected to terminal, cell body, and combination thereof. etc.

The current collector may be continuous or non-continuous. For example—parts of the current collector can be removed, cut, clamped and/or adjusted in order to have a proper connection and/or different connection methods to the electrical connecting unit, at any stage of the cell assembly.

The connection of the electrical connecting unit to the current collector can include external conductive material that may cause the conductive material be a part of the electrical connecting unit (such as soldering).

The connection process of the electrical connecting unit can be mechanical harnessing, clamping, welding, soldering, brazing or other, one or more methods can be combined together.

The suggested solution can be applied on any kind of cell such as but not limited to cylindrical and/or prismatic cells, in a hard case or in a laminate, or any other cell known in the industry.

The suggested solution can be applied on any kind of electrodes assembly process such as but not limited to Z-folding, winding, stacking or any other cell known in the industry.

This solution can be for either primary or secondary electrochemical cell.

The connection solution can be only in the anode side, only in the cathode side, or in both sides (which may require more than one electrical connecting unit).

The electrical connecting unit can be connected to the next electrical section by any conductive material (metallic or not) and a method that enables electric conductivity, one or more methods can be combined together.

The connecting of the electrical connecting unit and the next electrical section may include at least one out of mechanical harnessing, clamping, welding, soldering, brazing or other, one or more methods can be combined together.

The electrical connecting unit may serve as a heat conductive element to provide heat dissipation from the cell (electrodes) to terminal and outer environment. In other words, the electrical connecting unit may be heat conductive. It may be designed as thermal management element.

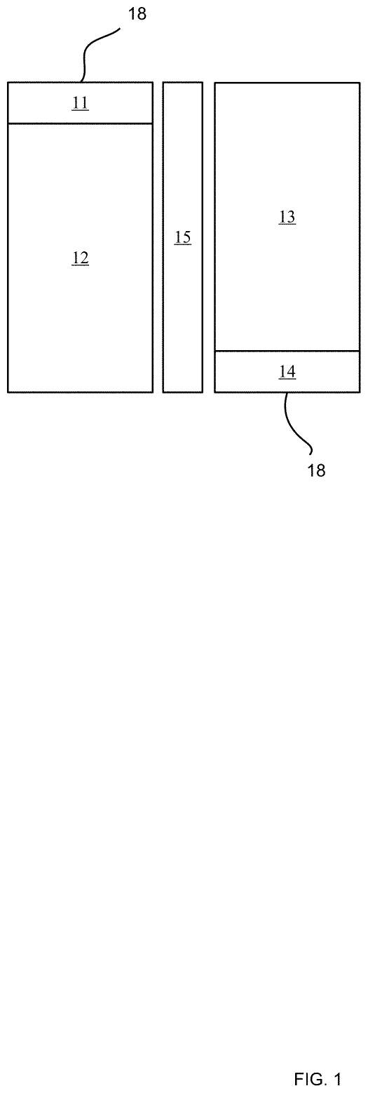

FIGS. 1-11 illustrate one or more parts of an electrochemical cell.

The various numbers are sued to describe the following parts:

Cathode tab 11.

Cathode sheet 12.

Anode sheet 13.

Anode tab 14.

Medium for ion conduction between electrodes 15.

Body 16.

Separator 17.

Conductors 18.

First module 21.

Second module 22.

Electrical connecting unit 31, 32, 34, 35, 37 and 38.

Half circle clamps connectors 51, 52.

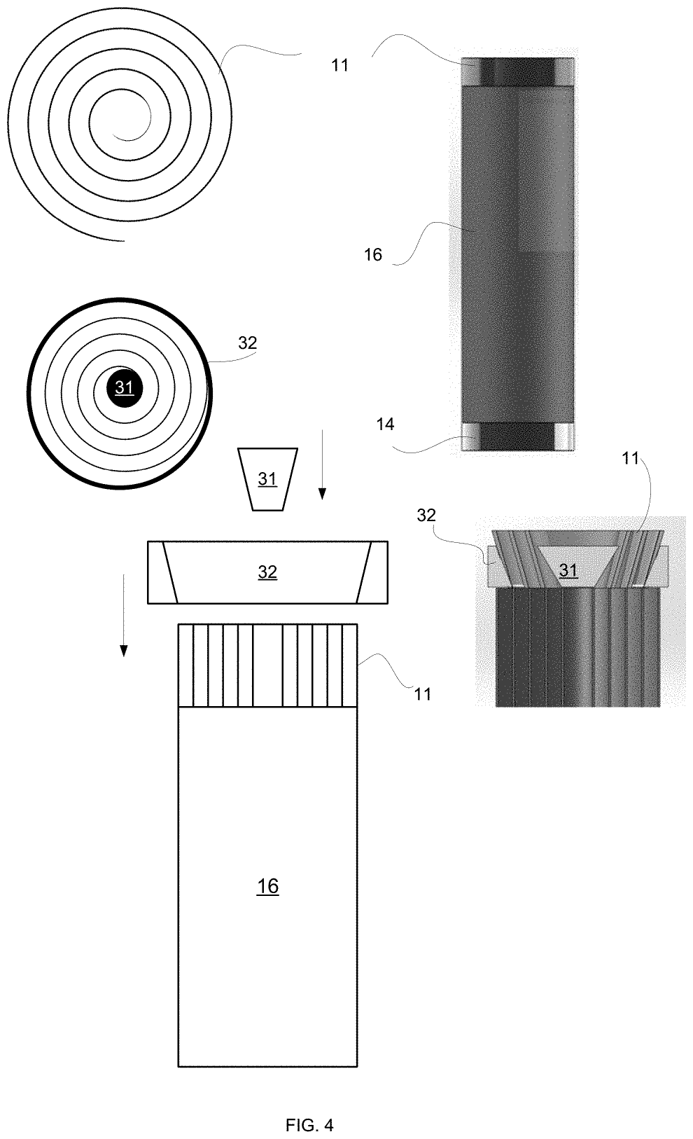

For simplicity of explanation FIGS. 1-12 illustrate electrical connecting units such as electrical connecting units 31, 32, 33, 35 and 37 that are connected a cathode tab, and electrical connecting units 34 and 38 connected to an anode tab. Any electrical connecting unit connected to the cathode tab 11 may be connected to the anode tab. One or more electrical connecting units may connect a single tab (out of an anode tab and a cathode tab). For example—FIG. 4 illustrates two electrical connecting units (denoted 31 and 32) that are connected at both sides of a cathode tab—and also compress the cathode tab between them. They may be referred to as a first electrical connecting unit 31 and a second electrical connecting unit 32. It should be noted that at least one of the tabs may be non-continuous to form segments—and that different electrical connecting units may be connected to different portions. For example there may be provided a third electrical connecting unit and a fourth electrical connecting unit—or any number of electrical connecting units connected to different portions of one or more tabs.

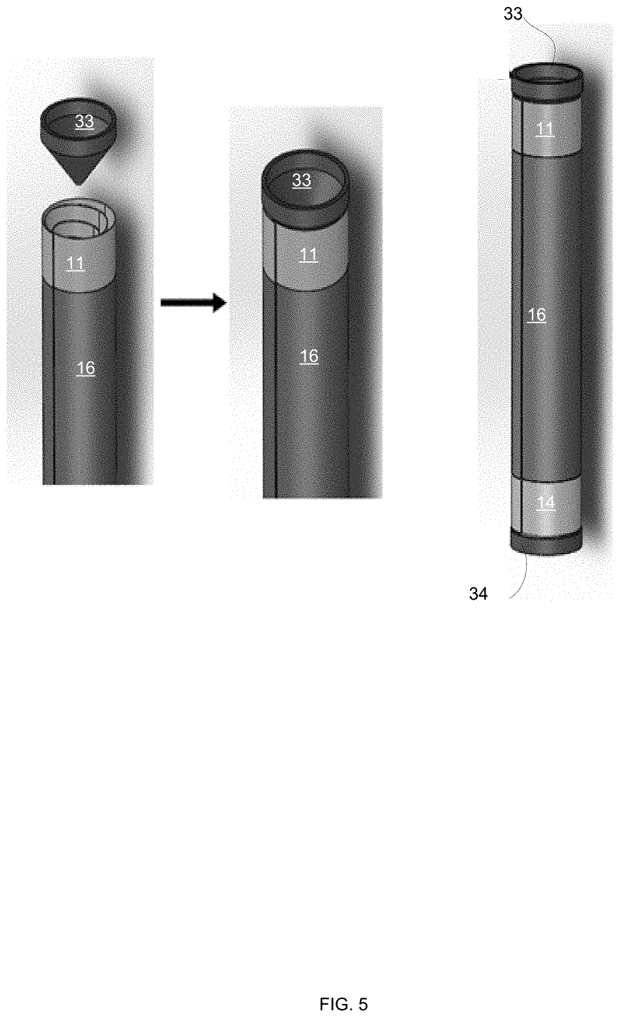

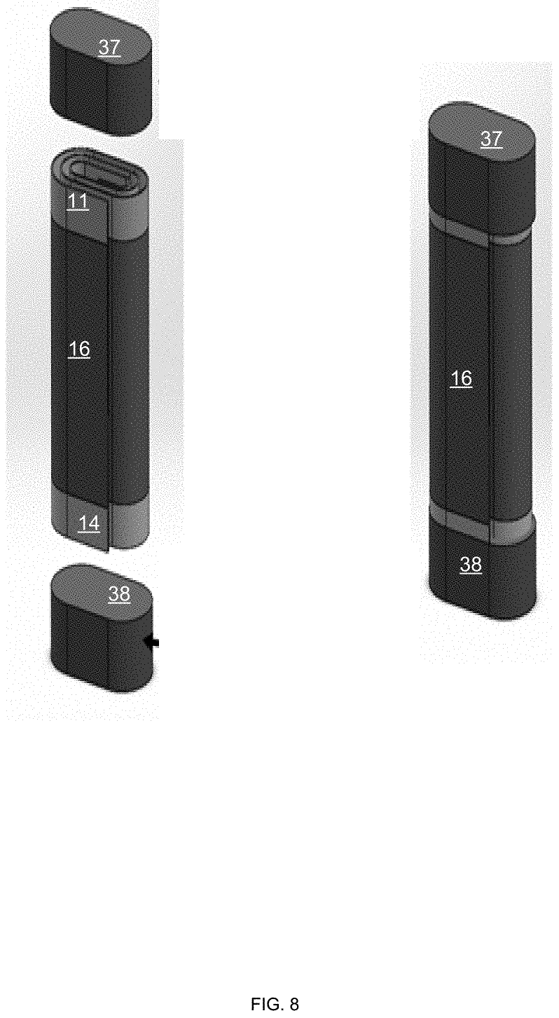

It should be noted that either one of the first and second electrical connecting units may be provided without the other electrical connecting unit. FIGS. 5, 6, and 9-11 illustrate electrical connecting unit 33, FIGS. 5 and 9-11 illustrate electrical connecting unit 34. FIG. 8 illustrates electrical connecting units 37 and 38.

Referring back to FIG. 1—which illustrates an example of parts of an electrochemical cell that include cathode tab 11, cathode sheet 12, anode sheet 13, anode tab 14, medium for ion conduction between electrodes 15 and conductors 18 that are electrically coupled to cathode tab 11 and anode tab 14.

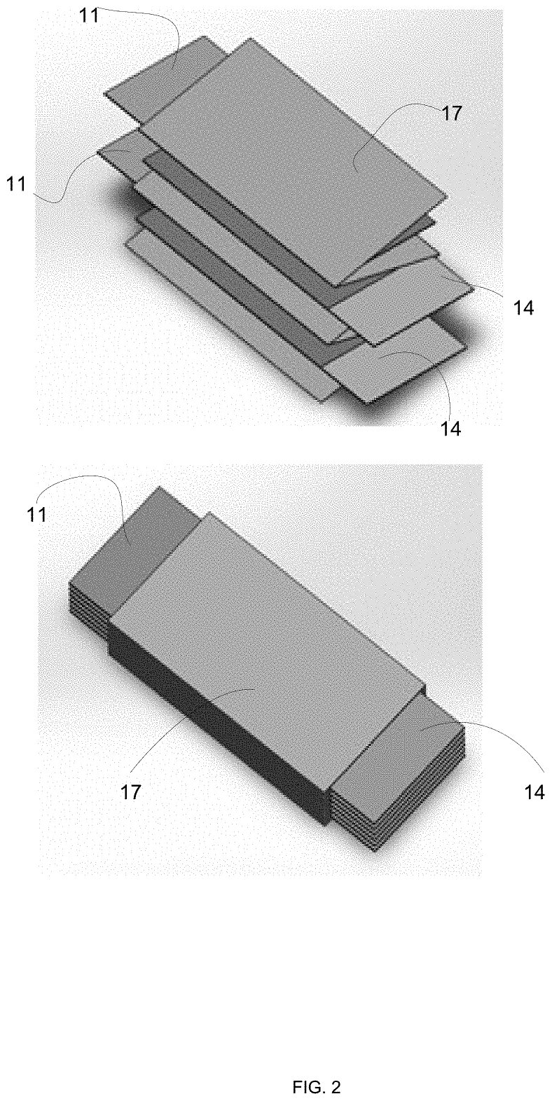

FIG. 2 illustrates an example of parts of an electrochemical cell having a folded form and include cathode tab 11, cathode sheet 12, anode sheet 13, anode tab 14 and separators 15.

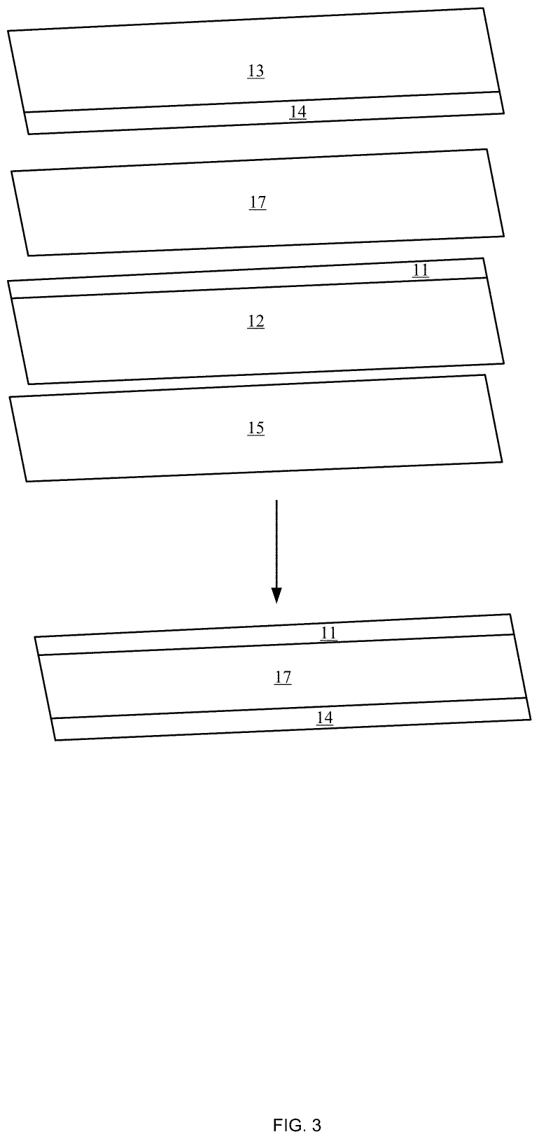

FIG. 3 is an exploded view of an example of parts of an electrochemical cell that are positioned on top of the other before being rolled. The parts include cathode tab 11, cathode sheet 12, anode sheet 13, anode tab 14 and separators 15. The figure also illustrates of a top view of the parts after being placed one on top of the other.

FIG. 4 includes several examples of cylindrically rolled elements, and an example of first electrical connecting unit 31 and a second electrical connecting unit 32 before compressing the cathode tab and after compressing the cathode tab. The figure also illustrates the cathode tab 11, the anode tab 14 and the body 16. The body includes the rolled separators, the rolled anode sheet and the rolled cathode sheet.

FIG. 5 includes several examples of cylindrically rolled elements, electrical connecting units 33 and 34. The roller elements include cathode tab 11, the anode tab 14, and the body 16.

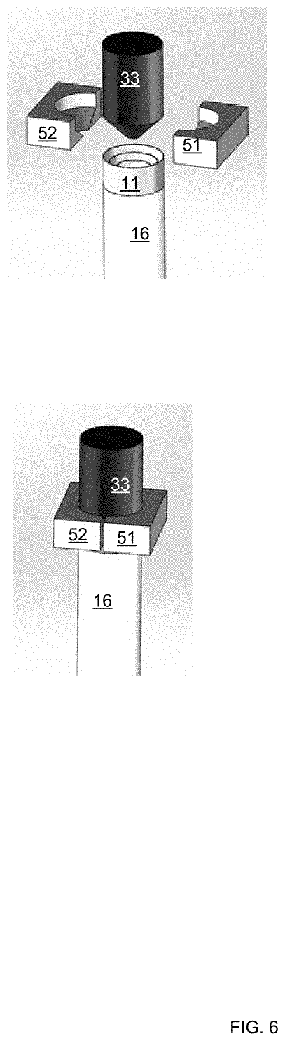

FIG. 6 includes an example of half circle clamps connectors 51 and 52 that are used to connect electrical connecting unit 33 to cathode tab 11 that is located above body 16.

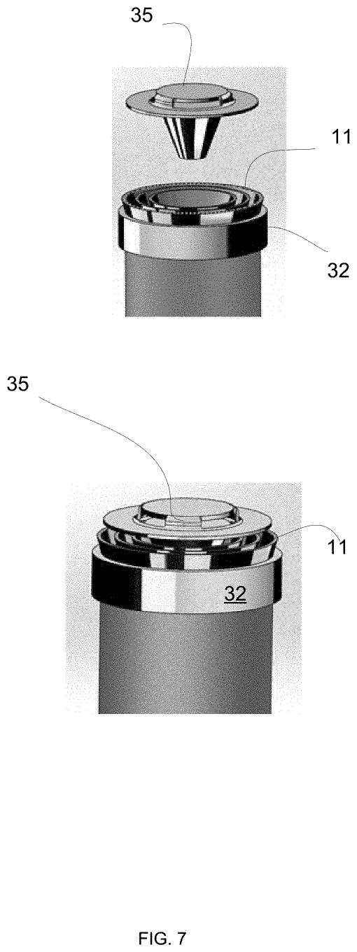

FIG. 7 includes an example of an electrical connecting unit 35 that is integrated with the cap of the electrochemical cell. FIG. 7 also illustrates a second 32, a cathode tab 11 and body 16.

FIG. 8 includes an example of flat jelly roll (prismatic jelly roll) cylindrically rolled elements, electrical connecting units 37 and 38. The rolled elements include cathode tab 11, the anode tab 14, and the body 16.

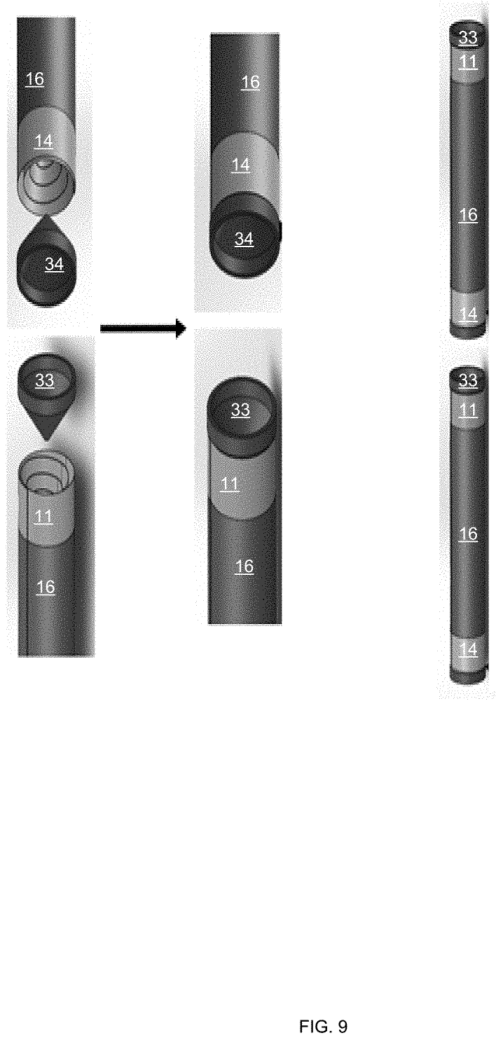

FIG. 9 includes an example of two models—each includes (from top to bottom) an electrical connecting unit 33, anode tab 14, body 16, cathode tab 14 and another electrical connecting unit 34.

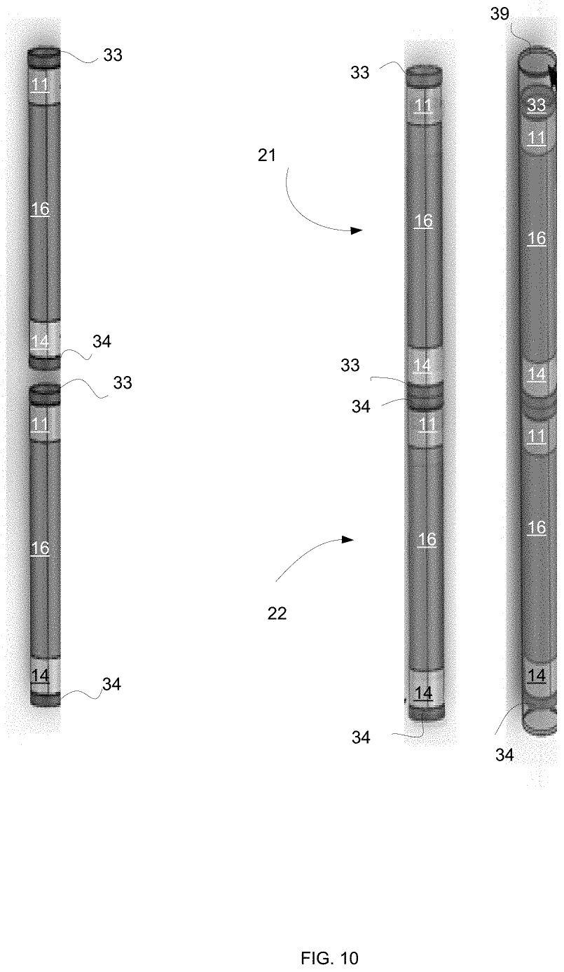

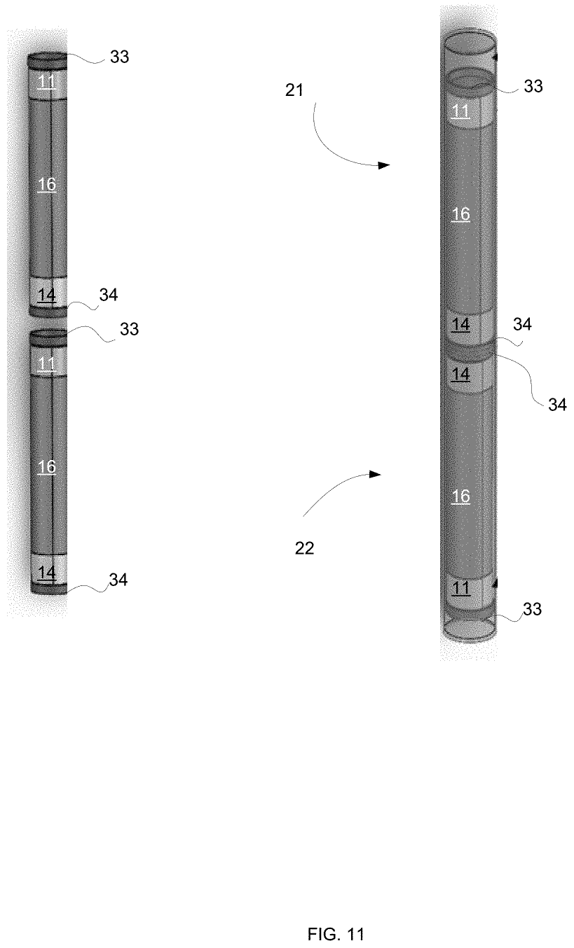

FIGS. 10 and 11 illustrate examples of two models first model 21 and second model 22. In FIG. 10 the models are serially connected and in FIG. 11 the models are coupled in parallel. Regarding the connectivity—conductors that extend outside the cell—are not shown for simplicity of explanation. The only connectivity that is shown is the connectivity between the lower electrical connecting unit of the first module 21 and the upper electrical connecting unit of the second module 22. Each model includes (from top to bottom) an electrical connecting unit 33, anode tab 14, body 16, cathode tab 14 and another electrical connecting unit 34.

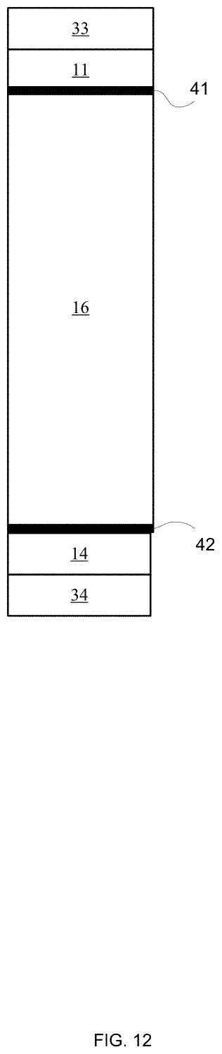

FIG. 12 illustrates isolators located at the exterior of one or more modules 21 and 22.

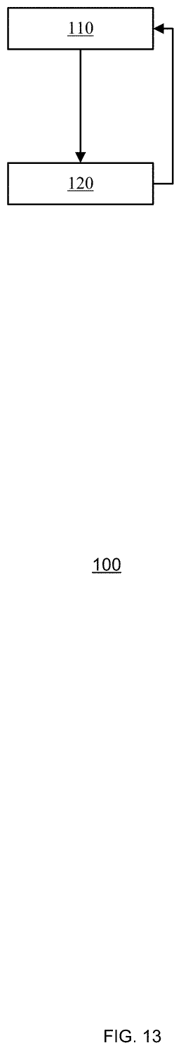

FIG. 13 illustrates an example of a method.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices inter-connected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first”, “second”, “third” and “fourth” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. An electrochemical cell, comprising:
a cathode sheet;
a cathode tab that extends from the cathode sheet;
an anode sheet;
an anode tab that extends from the anode sheet, the second direction differs from the first direction;
one or more separator sheets; and
a first electrical connecting unit;
wherein the cathode sheet, the anode sheet and the one or more separator sheets are wound around a common axis to form multiple windings; wherein the one or more separator sheets separate between the anode sheet and the cathode sheet;
wherein the first electrical connecting unit mechanically and electrically contacts a first portion of a first electrode tab, the first portion belongs to a first winding of the multiple windings;
wherein the first electrode tab is one of the anode tab and the cathode tab.

2. The electrochemical cell according to claim 1 comprising a second electrical connecting unit that mechanically and electrically contacts a second portion of the first electrode tab, the second portion belongs to a second winding of the multiple windings; wherein the first winding is closer to the common axis in relation to the second winding.

3. The electrochemical cell according to claim 2 wherein the first electrical connecting unit and the second electrical connecting unit are configured to compress the first winding, the second winding and any winding between the first winding and the second winding.

4. The electrochemical cell according to claim 2 wherein the first winding is an innermost winding and the second winding is an outmost winding.

5. The electrochemical cell according to claim 2 wherein the first electrical connecting unit and the second electrical connecting unit are configured to reduce a distance between the first winding and the second winding.

6. The electrochemical cell according to claim 2 wherein the first electrical connecting unit is configured to contact at least a central region of the first portion of the first electrode tab.

7. The electrochemical cell according to claim 2 wherein the first electrical connecting unit has a conical shape.

8. The electrochemical cell according to claim 2 wherein the second electrical connecting unit has a bevel inner surface.

9. The electrochemical cell according to claim 2 wherein the first electrical connecting unit and the second electrical connecting unit are electrically coupled in parallel to each other.

10. The electrochemical cell according to claim 2 wherein the first electrical connecting unit is mechanically coupled to a cap of the electrochemical cell or is a part of the cap of the electro-chemical cell.

11. The electrochemical cell according to claim 2 wherein the second electrical connecting unit is mechanically coupled to a case of the electrochemical cell or is a part of the case of the electro-chemical cell.

12. The electrochemical cell according to claim 1 wherein the first electrode tab is a continuous tab.

13. The electromechanical cell according to claim 1 wherein the first electrical connecting unit exhibits a heat conductivity.

14. The electromechanical cell according to claim 1 wherein the first electrical connecting unit is a shape memory alloy.

15. The electromechanical cell according to claim 1 wherein the first electrical connecting unit is thermally deformable.

16. The electrochemical cell according to claim 1 comprising a third electrical connecting unit that mechanically and electrically contacts a third portion of the first electrode tab, the third portion belongs to a third winding of the multiple windings.

17. The electrochemical cell according to claim 13 comprising a fourth electrical connecting unit that mechanically and electrically contacts a fourth portion of the first electrode tab, the fourth portion belongs to a fourth winding of the multiple windings; wherein the third winding is closer to the common axis in relation to the fourth winding.

18. The electrochemical cell according to claim 13 wherein the fourth electrical connecting unit is mechanically coupled to a case of the electrochemical cell or is a part of the case of the electrochemical cell.

19. A method for operating an electrochemical cell, the method comprises: discharging the electrochemical cell; wherein the electrochemical cell comprises a cathode sheet; a cathode tab that extends from the cathode sheet; an anode sheet; an anode tab that extends from the anode sheet, the second direction differs from the first direction; one or more separator sheets; and a first electrical connecting unit. The cathode sheet, the anode sheet and the one or more separator sheets are wound around a common axis to form multiple windings; wherein the one or more separator sheets separate between the anode sheet and the cathode sheet. The first electrical connecting unit mechanically and electrically contacts a first portion of a first electrode tab, the first portion belongs to a first winding of the multiple windings; wherein the first electrode tab is one of the anode tab and the cathode tab.
